(19) United States
(12) Patent Application Publication
(10) Pub. No.: US 2016/0040936 A1
(43) Pub. Date: Feb. 11, 2016

(54) METHOD OF PROCESSING MOLTEN METALS AND ALLOYS

(71) Applicant: Lev Amusin, Laguna Niguel, CA (US)

(72) Inventor: Lev Amusin, Laguna Niguel, CA (US)

(21) Appl. No.: 14/921,964

(22) Filed: Oct. 23, 2015

Related U.S. Application Data
(63) Continuation-in-part of application No. 14/492,149, filed on Sep. 22, 2014.
Application No. 14/492,149 is a division of application No. 14/260,846, filed on Apr. 24, 2014, now abandoned.
(60) Provisional application No. 61/965,711, filed on Feb. 6, 2014.
(60) Provisional application No. 62/283,620, filed on Sep. 8, 2015.

(51) Int. Cl. F27D 27/00; F27D 99/00; F27B 14/10

(52) U.S. Cl. CPC F27D 27/00; F27B 14/10; F27D 99/00

(57) ABSTRACT

A technological method of treatment of two or more materials forming a melt is disclosed. The melt may be subjected to turbulence under simultaneous combined action of resonance and hydraulic impact. Turbulence occurs when parameters of compelled vibration equalize with natural oscillations of the melt which is a function of geometric parameters of the crucible, the rheological, physical and mechanical characteristic of the two or more materials. An application of a low frequency mechanical vibration with an amplitude between 0.5-2.5 mm, frequency between 30-300 Hz, and acceleration between 15-50 G (Gravitational acceleration) may be performed on a hermetically sealed cylindrical crucible, vertically installed on a vibration unit. The heat for melting may be generated by a furnace (e.g., induction heater) installed around vibrating crucible. Various combinations of materials, batch and continuous processes are possible.

### CROSS-REFERENCE TO RELATED APPLICATIONS

This application claims priority to U.S. Provisional Patent Application No. 61/965,711 filed Feb. 6, 2014 and U.S. patent application Ser. Nos. 14/260,846 filed Apr. 24, 2014 and 14/492,149, filed Sep. 22, 2014, the entire contents of which are hereby incorporated by reference.

### STATEMENT RE: FEDERALLY SPONSORED RESEARCH/DEVELOPMENT

Not Applicable

### BACKGROUND

In the prior art, methods for the dynamic treatments of a melt during freezing exist. External forces are applied to induce fluid flow during a process of solidification in order to refine grain size. These methods include rotation of a mold, mechanical or electromagnetic stirring of the melt, and recasting. Under these conditions, grain structures of castings and ingots change from columnar-dendritic to equiaxed dendritic or globular when they are solidified in the presence of a sufficiently intense forced convection, which generally promote both the evacuation of superheat and the homogenization of the melt temperature.

Systems and methods for processing dispersed systems also exist. A dispersed system could be processed in a reactor with one or more supply lines for liquids, gases, and vacuum lines. The dispersed systems may be subjected to vibration by attaching a vibration unit to the reactor as a way to mix the liquids and gases and process the material through the system. Various combinations of materials may be used in such an application. Also, both static and dynamic processing systems are possible.

Several researchers have found that mechanical vibrations of ultrasonic character, when applied during the solidification of metals and alloys, modify conventionally obtained macrostructures and microstructures. The most commonly observed effect is the suppression of undesirable dendritic and columnar zones and the development of a fine-grained equiaxed structure. In fact, the effects produced when high-intensity sonic or ultrasonic waves are propagated through molten metals can be listed under three main categories: grain refinement, dispersive effects, and degassing resulting in reduced porosity. In addition, it has been found that vibrations of a mechanical origin are effective in increasing fluidity of the mold-filing ability of the melt (e.g., molten metals and alloys). There appear to be two distinct aspects which may explain such results, namely, resonance effects and fluid-flow phenomena.

An alloy is considered to be a material composed of two or more metals as well as metals and non-metals that are normally chemically immiscible. An alloy may be a solid solution of the chemical elements (a single phase), a mixture of metallic phases or an intermetallic compound with no distinct boundary between the phases. Solid solution alloys give a single solid phase microstructure, while partial solutions exhibit two or more phases that may or may not be homogeneous in distribution, depending on the thermal treatment of the material. An inter-metallic compound has one other alloy or pure metal embedded within another pure metal.

Alloys are used in some applications since their properties may be superior to those of the pure component elements for a given application. When the alloy cools and crystallizes, its mechanical, physical, and engineering properties will often be quite different from those of its individual constituents.

The first example is aluminum. A metal that is normally soft. Aluminum could be altered by alloying aluminum with other metal(s). For example, aluminum can be alloyed with magnesium and/or titanium, etc. Although each of those metals are soft also, the resulting aluminum alloy will be much harder and its physical properties, such as density, melting temperature, Young's modulus, electrical, and thermal conductivity as well as engineering properties such as tensile and shear strength are substantially different from those of the constituent metals and may, in some cases, supersede steel.

The second example is steel. Adding a small amount of non-metallic carbon to cast iron produces an alloy known as steel. Due to its very-high strength, hardness, toughness, and its ability to be greatly altered by different heat treatment, steel is one of the most common alloys. By adding chromium to steel, its resistance to corrosion can be enhanced, creating stainless steel.

Among the advanced processes of modern technology, there are number of different chemical and physical processes and mechanisms can be implemented in the process of crystallization and homogenization of alloys. Although the elements usually must be soluble in the liquid state, they may not always be soluble in the solid state. If the metals remain soluble when solid, the alloy forms a solid solution becoming a homogeneous structure consisting of identical crystals, called a phase. If the mixture cools and the constituents become insoluble, they may separate to form two or more different types of crystals, creating a heterogeneous microstructure of different phases. However, in other alloys, the insoluble elements may not separate until after crystallization occurs. These alloys are called intermetallic alloys because, if cooled very quickly, they first crystallize as a homogeneous phase, but they are supersaturated with the secondary constituents. As time passes, the atoms of these supersaturated alloys separate within the crystals, forming intermetallic phases that serve to reinforce the crystals internally.

### BRIEF SUMMARY

A turbulence phenomenon, which occurs as the result of simultaneous combined actions of low frequency mechanical resonance and so called “hydraulic hammer” impact for processing molten metals and alloys is disclosed. An application of the turbulence phenomena for processing of molten metals and alloys may be performed in a cylindrical hermetically sealed crucible, vertically installed on a vibration unit. One or more gas supply and vacuum lines may be in fluid communication with the crucible. The processed melt may occupy about 90-95% of an inner volume of the subject melting pot chamber. The remaining space may be filled with noble or other gases or be under vacuum. Heat to the crucible for melting or maintaining metals and alloys in a molten state may be provided by an induction furnace. The induction furnace may be installed around the vibrating crucible without touching or contacting it. The molten metals and alloys inside the melting pot are processed under vibration. The processed melt may be subjected to turbulence which arise as a result of the combined actions of low frequency mechanical resonance and hydraulic hammer impact.

The parameters of the vibration imposed on the crucible may be produced by a vibration unit and may be as follows: amplitude of 0.5-2.5 mm, frequency of 30-300 Hz, and acceleration of 15-50 G (Gravitational acceleration). These parameters of vibration may be adjusted to reach resonance of the molten metals, alloys and gases within the crucible depending upon geometric dimensions of the melting pot, the rheological, physical and mechanical characteristic of metals or alloys and gasses to be processed. Various combinations of materials may be used in such an application, and both static and dynamic processing systems, batch and continuous processes are possible.

### BRIEF DESCRIPTION OF THE DRAWINGS

The following detailed description should be considered in conjunction with the accompanying figures in which:

FIG. 1 shows a schematic diagram of an apparatus for generating turbulence, which arises as a result of simultaneous and combined actions of resonance and hydraulic hammer impact; and

FIG. 2 is a cross sectional view of a crucible of the apparatus shown in FIG. 1;

FIG. 3 shows a schematic diagram of a system for processing dispersed systems;

FIG. 4 shows the phases of a sample liquid-gas system as dependent on amplitude and frequency of a vibrational field; and

FIG. 5 shows the relationship of pressure P and time T required for conversion to a vibroturbulization state.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The various aspects described herein are not limiting, but rather are exemplary only. It should be understood that the described aspects are not necessarily to be construed as preferred or advantageous over other aspects. Moreover, the terms “embodiments of the invention”, “embodiments” or “invention” do not require that all embodiments of the invention include the discussed feature, advantage or mode of operation but may be combined in part or in whole with the other embodiments.

A turbulence phenomenon arises in a sealed cylindrical melting pot. The subject crucible may be vertically installed on a vibrating table of a mechanical, electro-dynamic, or electrohydraulic machine. The turbulence phenomenon occurs, when sinusoidal vertical low frequencies and small amplitudes of compelled force matches the frequency of natural oscillation of the content within the melting pot. By way of example and not limitation, in the example discussed herein, the content within the melting pot is molten metals and/or alloys. The turbulence phenomenon is a result of the simultaneous combined action of mechanical resonance and hydraulic hammer impact.

At the beginning of the process, after molten metals and alloys are disposed in the crucible and sealed inside, vibrational energy is applied to the melting pot. In this manner, vibrational energy is applied to the molten metals and/or alloys. When parameters of vibration are adjusted so that the vibrational energy approaches the inherent resonance of the molten metals and alloys, the free surface of the melt (e.g., molten metals and alloys) becomes ripple-coated. The size of the ripples may be proportional to oscillation frequency of the vibrational energy. As the amplitude and acceleration of the vibrational energy get closer to resonance parameters of the melt, splashes and separate gas bubbles may start developing in the molten metals and/or alloys. Continued increase of the amplitude of the vibrational energy may result in mass bubble immersion. The bubble immersion may develop spontaneously and its intensity may increase rapidly or exponentially with the system being under pseudo-boiling state. At this point, a state of resonance may be described as arriving almost instantaneously. There may be defined limits of the vibration fields in the process: the phase division zone, the turbulent zone, and the quasi-cavitation zone, as described below. These zones may be contingent upon the vibration parameters, internal dimensions and other characteristics of the crucible, the rheological, physical and mechanical properties of the processed molten metals and/or alloys.

To understand the subject process, the very last half-a-cycle of oscillation before achieving resonance and when the vibrating table with the crucible moves upwards will be discussed.

The last half-a-cycle of oscillation before before the imposed vibration causes resonance in the melt may be divided in several periods.

1-st Period. As a result of vibration at certain frequencies, acceleration, and amplitudes of vibration, the parameters of a compelled force comes nearer to a frequency of natural oscillation of the “excited” melt (e.g., molten metals and alloys) inside the melting pot. At the same time, the melt moves upward and, and suddenly, meet an obstacle: the top cover of the hermetically sealed melting pot. The top cover is rigid and stops the movement of the melt that strikes the top cover. Thus, vibration is applied to the melt at its resonance frequency and is simultaneously accompanied by “hydraulic hammer” impact, which is imposed on the upper portion of the volume of the melt. The upper portion of the volume of the melt is compressed and continues to move toward the top cover.

2-nd Period. When the upper portion of the volume of molten metals or alloys is compressed against the top cover proportionally, the vibrational energy is transferred to the melt. Under the law of conservation of energy, the kinetic energy of the upper portion of the volume of the melt deforms the top cover and the upper part of the melting pot walls within the elastic limit of the material of the top cover and the crucible walls to convert the kinetic energy of the compressing and moving melt into potential energy stored in the deformed top cover and the upper part of the crucible. At this point, the lower portions of the volume of the melt, which have not been fully compressed continue to move upwards. Simultaneously, the border of the zone of the elevated pressure (the shock wave) keeps moving in the opposite direction. The kinetic energy of the compressed molten metals and alloys and the potential energy of elastic deformations of the melting pot/reactor cause the development of zones within the melt with different internal pressures.

3-rd Period. At this time, the shock wave has reached the bottom of the crucible. The bottom, wall, and top cover of the melting pot (or crucible) are external borders of the melt. The bottom, wall, and top cover being ridged do not add the kinetic energy to the moving molten metals and/or alloys. Besides, the bottom, wall, and top cover (the external borders) of the processed melt do not fix movement of a shock wave, and wave, which extends inside melting pot, dissipates in it, and disappears.

4-th Period. The internal pressure of the volumes of molten metals or alloys at the crucible bottom is less than at the upper part of the crucible. As a result, the compressed melt tries to change its direction of movement toward lower-pressure zones. In doing so, the potential energy of elastic deformation is converted into kinetic energy. During that time, the movement of the crucible has already begun to move in an opposite direction. As a result, the border of the zone of the motionless melt, being under the increased pressure, tries to move from the melting pot bottom toward its top, leaving at the crucible bottom a zone of lowered internal pressure in which the melt moves back to the bottom. The speed of movement of the border of the lower-pressure zone is equal to the speed of distribution of elastic deformations in the medium. This speed is equal to the speed of a sound in the molten metals and alloys. However, the difference of pressure on the border is less than the pressure difference at shock wave propagation. The reasons for this behavior are anomalies in the process of dissipation of the shock wave at the melting pot bottom during the previous period. With the pressure change, the potential energy of elastic deformation minus losses is converted again into kinetic energy of processing molten metals or alloys. Therefore the speed of the “uncharged” melt is practically equal to speed of melt before it stops. However, now the speed gradient is pointing in the opposite direction.

5-th Period. At the moment when the border of the lower-pressure zone reaches the crucible upper cover, in other melting pot zones, the melt is under lower pressure and tries to return with speed equal to the initial speed of the first impact. The processed molten metals or alloys move toward the crucible bottom and, by virtue of inertia, attempts to separate from the cover. Therefore, due to a strong initial impact near the melting pot cover, the zone of low pressure is formed. In this zone, melt is absent and a pressure level close to zero has been formed. Thus, in the upper portion of the crucible, the vacuum zone is formed. During this period, the separation of the melt from the melting pot upper cover does not always occur. In order to achieve this condition, the speed of the movement of the processed metals or alloys should be high enough, and the design and materials crucible case and covers have to be rigid enough to generate a hard impact. If the design and materials of the crucible case and covers are soft, liquid metals or alloys would not be able to separate from the cover, and the vacuum will not be formed. Nevertheless, during the discharge process, the pressure inside the crucible, including zones directly under the top cover, will be less than the internal pressure inside the melt in other zones (volumes).

The occurrence of turbulence requires time. The length of this pre-turbulence state depends on the accumulation of the appropriate amount of gas bubbles in the melt. This period is variable from seconds to minutes because the conversion of the processed system into resonance and depends on the vibration parameters, the content of the dissolved and free gas, the presence of surface-active compounds or intravenous inclusions, the irregularity of the crucible chamber's wall, the ratio between melt-gas volumes, the viscosity of molten metals or alloys, etc. Therefore, the determination of vibration parameters necessary to generate the turbulence phenomena are require experiments due to necessity of matching of the compelled vibration to natural oscillation of the crucible and its contents. In particular, experiments may be conducted for melt/gas ratio from 90 to 95 percent of melt to 5 to 10 percent of gas. Experiments for other ratios may also be conducted, depending on the application.

The use of the described turbulence phenomenon simplifies a process of vibration treatment and substantially accelerates this process. The described process may allow the production of a product (e.g., alloy, gassed metal) of which the quality is equal to or better than those produced in traditional ways. Increased production and profitability are obvious benefits. The subject phenomenon may even make carrying out processes previously impossible or economically not feasible with traditional methods possible. Additionally, due to the inherent characteristics and increased mobility of the system, it may be possible to create new complex technological methods.

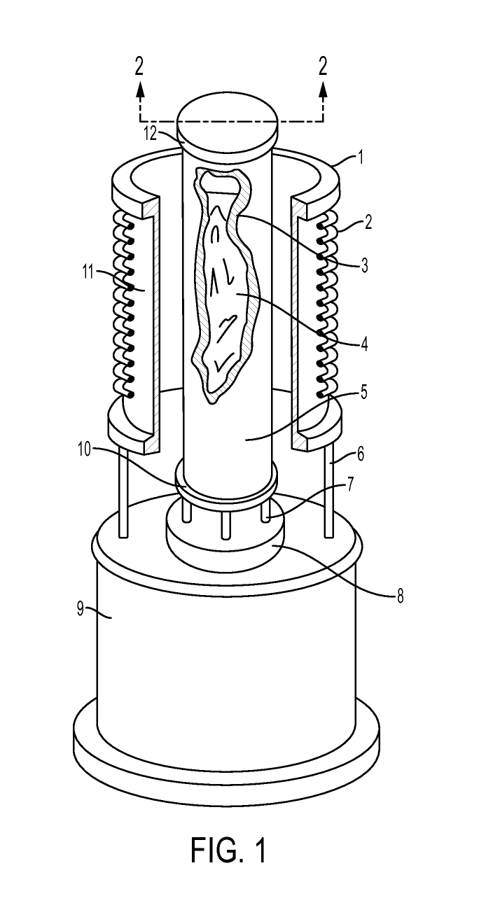

Referring to exemplary FIG. 1, a schematic of a vibration processing system is shown which may include an induction furnace 11 (including crucible wall 1, electric induction coil 2, and power and control equipment), vibration machine 9, and melting pot 5 (including upper lid 12, outer crucible structure 3, inner layer(s), bottom lid 10). This system could be used for turbulence treatments to process molten metals and alloys 4 or melt. The system 100 may include the induction furnace 11 (including crucible wall 1, electric induction coil 2, and power and control equipment), a melting pot 5, a vibration unit 9, gas supply or vacuum lines (not marked), and a discharge line or tap-hole (not marked). The number of each subcomponent(s) may vary depending upon applications. Induction furnace 11 may be installed on the rigid frame of the vibration machine with mounting rods 6. The melting pot 5 may be installed on the vibration table 8 of the vibration machine 9 with mounting rods 7. A gas supply or vacuum line may proceed through the upper lid 12 with pipe(s), check-valve(s), diverter valve(s), vacuum pump, and gas supply pump, and storage tanks. A discharge line (or tap-hole) may be included in the bottom lid 10 and a shut-off valve may be incorporated into the discharge line. The internal dimensions of induction furnace may be sufficiently large to allow the melting pot chamber 5 to oscillate vertically without touching or contacting an inner surface of the induction furnace. The molten metals and alloys 4 fill the melting pot chamber about 90 to 95 percent of its internal volume.

When a melt 4 is placed into the crucible and is subjected to vibrational forces with any variety of combinations of amplitude, acceleration, and frequency, depending on the application and the molten metals or alloys 4 being processed, the molten metals and alloys may become turbulent. For example, vibration with frequencies from 35 Hz to 300 Hz, acceleration from 15 to 50 G (Gravitational acceleration), and amplitudes from 0.5 mm to 2.5 mm may be used to make the melt turbulent.

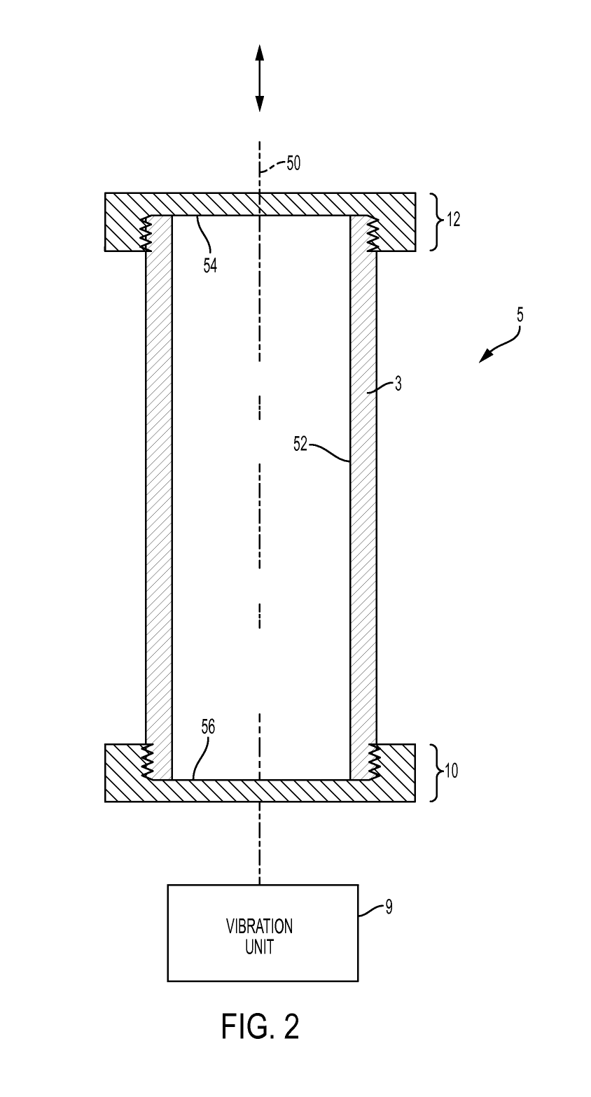

Referring now to FIG. 2, the melting pot chamber 5 is shown schematically as being attached to the vibration table 8 of the vibration machine 9. The vibration machine 9 imparts vibration to the melting pot chamber 5 in a strict vertical direction, in a longitudinal axis 50 defined by a cylindrical structure referred to as the outer crucible structure 3 of the melting pot chamber 5. Moreover, the longitudinal axis is aligned to the upper and lower lids being coaxial with the longitudinal axis but on opposed ends of the crucible. The vibration unit 9 imparts a frequency between 35 Hz and 300 Hz to the melting pot chamber 5, and with amplitude between 0.5 mm to 2.5 mm at accelerations between 15 to 50 G.

The inner surface 52 of the outer crucible structure 3 may have a circular cross-sectional configuration. The inner surface 52 of the outer crucible structure 3 may have a cylindrical configuration, hourglass configuration so long as the centers of the circular cross-sections along the length of the outer crucible structure 3 are aligned in a straight line to define the longitudinal axis 50. Other non-straight configurations are contemplated, but the straight line configuration of the longitudinal axis 50 is described herein.

The outer crucible structure 3 may be designed and fabricated from any material that does not melt when the molten metal and alloy 4 are disposed within the melting pot chamber 5 and has a rigidity and hardness allows to generate hydraulic impact. The material of the outer crucible structure 3 cannot melt when the molten metal and alloy 40 are disposed within the melting pot chamber 5. The purpose is that when the molten metals and alloys 4 move upward and forcibly contacts the inner surface 54, the upper lid 12 and the inner surface 54 remain stationary so that the molten metals and alloys 4 close to the lid 12 experience a hydraulic hammer impact against the inner surface 54 of the upper lid 12. When the molten metal and alloy 4 moves downward and forcibly contacts the inner surface 56, the lower lid 10 and the inner surface 54 remains stationary so that the molten metals and alloys 4 close to the lid 10 experiences a hydraulic hammer impact against inner surface 56 of the lower lid 10.

The upper and lower lids 12, 10 may be design and fabricated from a material having a rigidity and hardness to facilitate the hydraulic hammer impact on the molten metals and alloy 4 as it is vibrated in the melting pot chamber 5. The upper and lower lids 12, 10 may be secured to the outer crucible structure 3 by way of a threaded connection or other connections known in the art or developed in the future.

During use, the upper lid 12 may be removed from the outer crucible structure 3 and molten metals and alloys 4 may be poured into the outer crucible structure 3. The molten metals and alloys 4 may be filled up to about 90% to 95% of an interior volume defined by the inner surface 52 of the outer crucible structure 3 and the inner surfaces 54, 56 of the upper and lower lids 12, 10. The remainder of the interior volume may be filled with an inert or other gas (depending upon application) or be vacuumed so that there is an absence of gas in the remaining 5% to 10% of the interior volume. The induction furnace 11 heats the crucible chamber 5 to maintain the molten metals and alloys in a molten state within the melting pot chamber 5.

Alternatively, the molten metals and alloys 4 may be filled into the outer crucible structure 3 in a solid state then melted into the molten state by way of the induction furnace 11.

When the turbulence phenomenon arises under the simultaneous combined actions of resonance and hydraulic hammer impact, any of the following may occur:

a) The free surface of melt may disappear;
b) The processed melt may fill up the total internal volume of the melting pot;
c) Low-pressure and high-pressure mass-transfer zones may develop within the melt;
d) Along with the increase of internal pressure under turbulence, the development of fields of internal pressure (pressure differentials) between different mass-transfer zones may take place;
e) The sufficient intensification of specific sounds, accompanying the turbulence phenomenon may be generated.

Several exemplary embodiments will follow, referring generally to the description above and exemplary FIGS. 1 and 2:

According to a first exemplary embodiment, melting pot 5 may be filled with melt 4 up to about 95 percent of the internal volume of the melting pot 5. Once the melt 4 has been loaded into melting pot 5, the upper cover 12 may be closed, sealing the chamber. After that, a noble or other gas may be added to melting pot 5 by way of gas supply line into the crucible 5. All valves leading in and out of melting pot may be closed. Turbulence of the melt may be achieved in several steps. In the first step the vibration amplitude may be maintained in a range between 0.5 and 2.5 mm, vibration acceleration may be maintained in a range from 15 to 50 G (Gravitational acceleration), and the vibration frequency may be maintained to the optimal level, which brings the processed molten metal and alloy 4 to a resonance condition. The critical frequency depends on the geometrical ratio between internal diameter and internal height of the melting pot chamber, the structural and mechanical characteristics of the processed metals or alloys, and other factors associated with the melting pot and the contents within the melting pot. The vibration parameters should be determined experimentally on a case-by-case basis, as discussed above.

Upon reaching the critical vibration parameters to generate turbulence in the melt, the melt may burst into turbulence. The appearance of massive bubbles and mass-transfer zones inside the melt will develop. Along with an increase of the overall pressure inside the processed melt and the development of pressure differentials between adjacent zones, there may be changes in strength and tone of the accompanying sounds.

According to a second exemplary embodiment, the melting pot chamber 5 may be filled with molten metals and alloys 4 at a pre-specified ratio. After the melting pot chamber 5 is filled, the upper lid 12 may be closed, which may effectively seal the melting pot chamber 5. The vibration unit may generate a vibration with amplitude, acceleration, and frequency critical to this particular melting pot filled with this particular melt 4. Upon reaching the critical vibration parameters of this particular melting pot and particular melt, the melt may become turbulent spontaneously, achieving intensive mass-transfer zones, an increase of internal pressure, development of fields of pressure differences, and changes in strength and tone of the specific accompanying sounds.

According to a third exemplary embodiment, the processed molten metals and alloys 4 may be loaded into the melting pot 5 chamber. The upper lid 12 may be closed, which may effectively seal the melting pot 5, and the air from the melting pot chamber 5 may be pumped out by a vacuum pump. After the desired level of vacuum is reached, the melting pot chamber 5 may be subjected to vibration with amplitude, acceleration, and frequency close, but not exactly equal to critical parameters. Upon achieving optimal ratio between all parameters of the process, the melt may become turbulent immediately, achieving intensive mass-exchange zones, an increase of pressure, development of fields of pressure differences, and changes in strength and tone of the specific accompanying sounds.

According to a forth exemplary embodiment, the melting pot 5 chamber may be filled with the melt to be processed. Then, the melting pot chamber may be subjected to vibration with amplitude, acceleration, and frequency critical for this particular melting pot 5 chamber and melt 4 to be processed and a small amount of noble or special gas or metal with a different coefficient of surface tension. The noble or special gas or metal with different coefficient of surface tension intensifies the occurrence of the turbulence, which arises instantly.

In the above description of the various aspects, the crucible is described as being installed vertically and the vibration unit operative to oscillate the crucible vertically. However, this vertical nomenclature was used for convenience and not to limit the aspects of the mechanism to the vertical orientation. Rather, other orientations (e.g., horizontal, skewed from the vertical) are also contemplated so long as the longitudinal axis of the crucible is aligned to the direction of vibration generated by the vibration unit.

The foregoing description and accompanying figure illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments may be designed by those skilled in the art without departing from the scope of the invention as defined by the following claims. The various aspects of the system and method described herein was in relation to molten metals and alloys mixed in the melting pot. However, the molten metals and alloys may be at least two immiscible metals or at least one metal and at least one gas.

In another embodiment, the disclosed physicochemical process and phenomenon, referred to herein as vibroturbulization, in the beginning may look like cavitation. However, the known cavitation phenomenon occurs when a liquid is pumped through an orifice, whereas according to one use of the disclosed vibroturbulization phenomenon, an impact pseudo-boil may form a substantially homogeneous liquid-gas system that may fill the internal volume of a sealed chemical apparatus when under certain low-frequency vibration conditions a dispersed liquid interacts with a dispersed gas. The source of the mechanical vibration may be a shaker. The disclosed apparatus may be installed on top of a vibration platform and the whole apparatus may vibrate under certain low-frequency vibration conditions.

The use of vibroturbulization may make it possible to simplify many processes in applied technology and, at the same time, essentially intensify them. Many time-consuming processes can be substantially accelerated.

The use of the vibroturbulization phenomenon may allow the production of a product of which the quality is equal to or better than those produced in traditional ways. Increased production and profitability are obvious benefits. This phenomenon may even make it possible to carry out processes previously impossible or economically not viable with traditional methods. Additionally, due to the inherent characteristics and increased mobility of the system, it may be possible to create new complex technological methods. This new process of chemical technology is capable of applying intensified energy to the processing system, which may promote the homogenization, emulsification, and preparation of suspensions, pastes, creams, foams, and the like, and also may promote reaction rates in extraction, recuperation, and other processes. A non-exhaustive list of the applications of the disclosed system and methods includes: the production of cosmetic creams, shampoos, and pastes; the production of food products such as mayonnaise and butter; the extraction of compounds from raw vegetative matter; the production of paints, varnishes, and enamels; the preparation of an emulsified growth medium for microbes; and any other production or preparation which may benefit from a high throughput of an emulsified, mixed, or dispersed product.

At the beginning of the process, as vibrational energy is applied to the system, the free surface of a given fluid may become ripple-coated, with the size of the ripples being proportional to oscillation frequency. As the amplitude grows, splashes and sprinkles may appear on the surface and separate gas bubbles may start penetrating into the liquid. Continued increase of the amplitude can result in mass bubble immersion. The bubble immersion may develop spontaneously in an avalanche-like way with the system pseudo-boiling and a state of vibroturbulization arrived at almost instantaneously. Research performed showed that there may be defined limits of the vibration fields in the process: the phase division zone, vibroturbulization zone, and quasicavitation zone, as described below. These zones are contingent upon the vibration parameters, dimensions of the reactor chamber, and the structural and mechanical properties of the processed chemical compounds.

A finite period of time may be required to bring the system to the vibroturbulization state. The length of this period depends on the accumulation of the appropriate amount of gas bubbles in the liquid. This period is variable from seconds to minutes because the conversion of the processed system into the vibroturbulization state depends on the vibration parameters, the content of the dissolved gas, the presence of surface-active compounds or intravenous inclusions, the irregularity of the reactor chamber's wall, the liquid-gas volume ratio, and the viscosity of liquids. Therefore, some minimal experimentation may be used to optimize a system when new parameters are used. In particular with liquid-gas systems, a ratio of 90-95% liquid to 5-10% gas may be preferable, but other ratios may also be used, depending on the application. Furthermore, according to at least one exemplary embodiment, once a desired ratio has been established and vibroturbulization has been reached, the user of the system disclosed herein may achieve a continuous production process. In the continuous production process, chemical compounds may be continually inputted as a processed, dispersed system is continuously outputted.

Additionally, in the process of achieving and using the vibroturbulization phenomenon, hydrodynamic heating of the system may be achieved. Further, the average pressure in the dispersed system may increase and remain at an elevated level during the entire time the vibroturbulization condition is maintained.

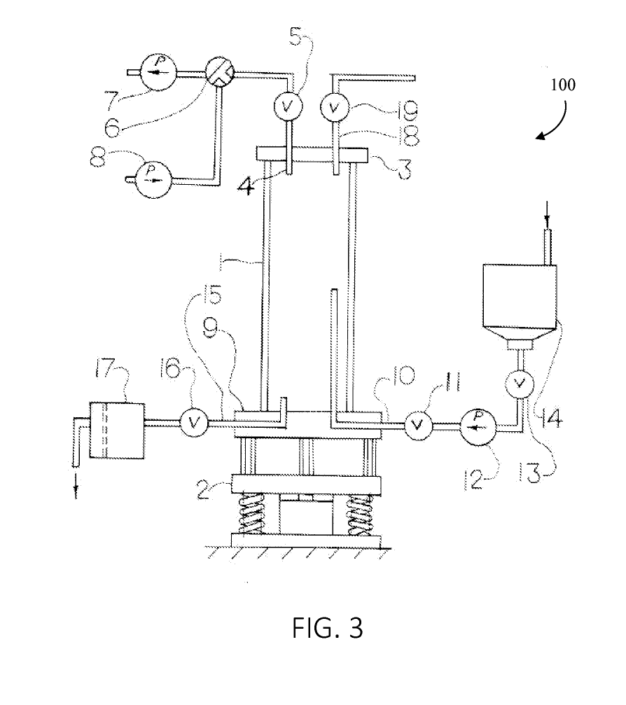

Referring to exemplary FIG. 3, a schematic for a chemical processing apparatus 100 may be disclosed. The apparatus 100 may be used for processing various dispersed systems, including liquid-liquid, liquid-gas, liquid-liquid-gas, liquid-solid, liquid-liquid-solid, liquid-liquid-solid-gas, or as desired. The apparatus 100 may include a reactor, a vibration unit, a gas supply line, a liquid supply line, a drainage line, and a ventilation line. The number of each sub-component may vary depending upon the application. Reactor 1 may be coupled to vibration unit 2. A gas supply line may include lid 3, pipe 4, check-valve 5, diverter valve 6, vacuum pump 7, and gas supply pump 8. A liquid supply line may include a lid 9, pipe 10, shut-off valve 11, supply pump 12, supply valve 13, and storage tank 14. A drainage line may include a pipe 15, shut-off valve 16, and drain tank 17. A ventilation line may include pipe 18 and valve 19.

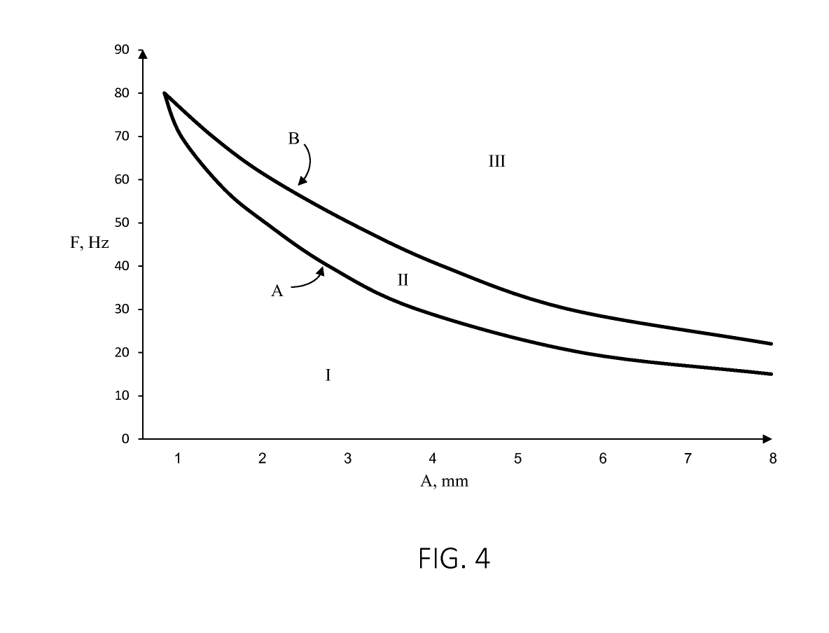

Referring to exemplary FIG. 4, a phase diagram may show the phases of a sample liquid-gas system as dependent on amplitude, in millimeters, and frequency, in Hertz, of a vibrational field. Phase I denotes the phase where the free surface of the liquid-gas interface is preserved. Line A represents the appearance of single gas bubbles. Phase II denotes the phase where there is a coexistence of the free surface of the liquid and of the gas bubbles or their aggregates captured by the liquid. Line B represents the conversion of the system into the vibroturbulization state. Phase III is the vibroturbulization state, and in this phase a substantially homogenous hydrosol may be formed.

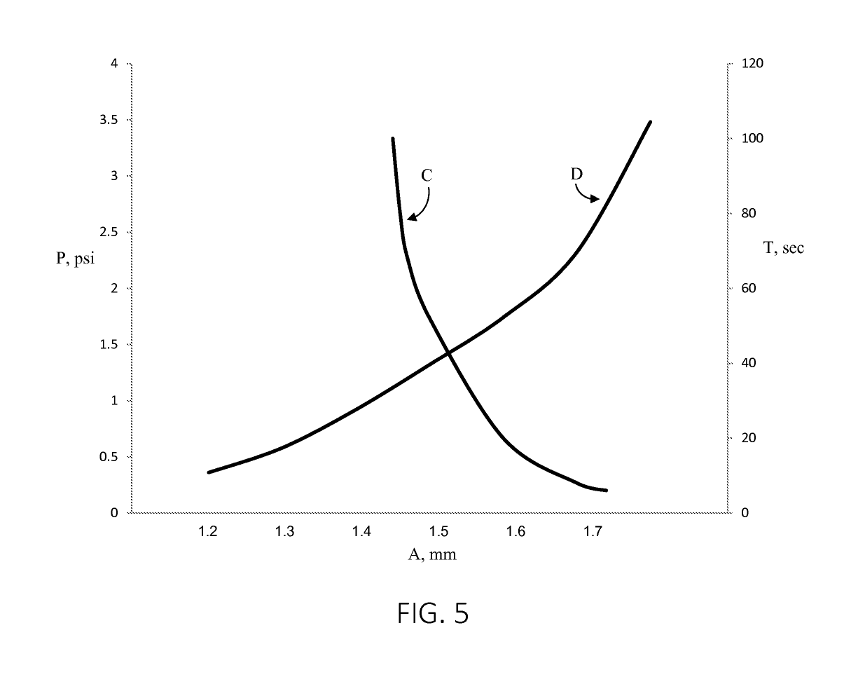

Exemplary FIG. 5 may show the relationship of pressure P and time T required for conversion to a vibroturbulization state when vibrating a sample liquid-gas system at 57 Hz. Line C shows the relationship of time to amplitude of the applied vibrational field to achieve vibroturbulization, and line D shows the relationship of pressure to amplitude of the applied vibrational field to achieve vibroturbulization.

When a system is undergoing vibroturbulization, the system may be subjected to vibrational forces with any of a variety of combinations of amplitude and frequency, depending on the application and the system being processed. For example, vibration with frequencies from 35 Hz to 100 Hz and amplitudes from 0.5 mm to 5 mm may be used. When undergoing vibroturbulization any of the following may occur:

a) The free surface of a processed liquid disappears;

b) The surface of separation between phases increases;

c) The processed dispersed system fills up the total internal volume of the reactor chamber;

d) The development of mass-transfer zones is observed;

e) Along with the increase of internal static pressure under vibroturbulization conditions, the development of fields of different internal pressure (pressure differentials) between different zones of chemical apparatus and mass-transfer are observed;

f) The sufficient intensification of specific sounds, accompanying the process of vibroturbulization.

Several exemplary embodiments follow, referring generally the description above and exemplary FIGS. 3-5:

According to a first exemplary embodiment, reactor chamber 1 may be filled with a liquid to be processed up to 95% of the internal volume. For this purpose valves 5 and 16 are closed; valves 11, 13, and 19 are open, and the necessary amount of liquid may be delivered from storage tank 14 by pump 12. Once the liquid and gas have been added to reactor chamber 1, all valves leading in and out of reactor chamber 1 may be closed, sealing the chamber.

The vibration effect on reactor chamber 1 may be achieved in several steps. In the first step the vibration amplitude may be maintained in range between 0.5 mm and 5 mm and the frequency may be dropped to the optimal level which brings the processed dispersed system to a vibroturbulization state. The optimal frequency can depend on the geometrical ratio between diameter and height of the chemical chamber, and the structural and mechanical characteristics of the processed systems and should be determined experimentally on a case-by-case basis, according to the principles set out above.

Upon achievement the optimal frequency, the processed dispersed system may convert into the vibroturbulization state. The appearance of massive bubbles and mass transfer zones may be observed. Along with an increase of the overall pressure inside the dispersed system and the development of pressure differentials between adjacent zones there may be changes in strength and tone of the specific accompanying sounds.

According to a second exemplary embodiment, reactor chamber 1 may be loaded up to 100% of the internal volume with a liquid to be processed and subjected to vibration with amplitude and frequency optimal to this particular system. After the vibration regimen becomes stable, valve 16 may be open, and the liquid from reactor chamber 1 may drain, for example by gravity, into tank 17. After the ratio between liquid and gas in reactor 1 reaches an optimal level, the processed dispersed system may convert into the vibroturbulization state spontaneously, achieving intensive mass-transfer and mass-exchange zones, an increase of pressure, development of fields of pressure differences, and changes in strength and tone of the specific accompanying sounds. The speed of liquid flow could be controlled by, for example, the opening of valve 16, the opening of valve 19, and/or the opening of valve 5 and pump 8. According to this or another embodiment, a continuous processing, including a continuous input and discharge, may be achieved.

According to a third exemplary embodiment, reactor chamber 1 may be subjected to vibration while empty with amplitude and frequency optimal to the system to be processed. After the vibration regimen becomes stable, valves 19 and valve 11 may be opened and the processing components are pumped into the reactor chamber 1 by delivery pump 12. Upon achieving the optimal ratio between liquid and gas, the system may convert into a vibroturbulization state instantly, achieving intensive mass-transfer and mass-exchange zones, an increase of pressure, development of fields of pressure differences, and changes in the strength and tone of specific accompanying sounds.

According to a fourth exemplary embodiment, reactor chamber 1 may be filled with a dispersed system to be processed to the optimal ratio for this particular liquid-gas (or other) combination. After the chemical chamber is filled, valves 5, 11, 16, and 19 may be closed, which may effectively seal reactor chamber 1, and vibration with amplitude and frequency optimal to this particular chamber and system may be applied. Upon the achievement of a critical number of bubbles in the liquid, the system may convert into a vibroturbulization state spontaneously, achieving intensive mass-transfer and mass-exchange zones, an increase of pressure, development of fields of pressure differences, and changes in the strength and tone of specific accompanying sounds.

According to a fifth exemplary embodiment, reactor chamber 1 may be filled with a system to be processed up to 100% of the internal volume of chemical chamber. Valves 5, 11, 16, and 19 are shut off and vibration, with amplitude and frequency, which are close to but not exactly equal to optimal parameters, may be applied. After the vibration regimen becomes stable, valve 16 may opened, and a portion of processed liquid may drain into tank 17.

This use of the system may cause the occurrence of certain space filled with the saturated vapor of processed chemical components under the upper lid 3. Upon achievement of a critical number of bubbles in the liquid, the system may convert into a vibroturbulization state spontaneously, achieving intensive mass-transfer and mass-exchange zones, an increase of pressure, development of fields of pressure differences, and changes in the strength and tone of specific accompanying sounds.

According to a sixth exemplary embodiment, reactor chamber 1 may be pumped out by a vacuum pump 7. Valve 5 may be open, and valves 11, 16, and 19 may be closed. After the desired level of vacuum is reached the reactor chamber 1 may be subjected to vibration with amplitude and frequency close, but not exactly equal to optimal parameters. The chemical components may be loaded into the chamber by pump 12, through valve 11.

After the ratio between liquid and gas reaches an optimal level, the processed dispersed system may convert into a vibroturbulization state spontaneously, achieving intensive mass-transfer and mass-exchange zones, an increase of pressure, development of fields of pressure differences, and changes in the strength and tone of specific accompanying sounds.

According to a seventh exemplary embodiment, reactor chamber 1 may be filled with a system to be processed in the optimal ratio and then may be subjected to vibration with amplitude and frequency optimal for this particular reactor chamber and system to be processed. For the purpose of achieving intensification of the turbulent state, an initiator—a small amount of gas or liquid with a different coefficient of surface tension, may be administered into the chamber. Upon achieving the optimal ratio between liquid and gas, the system may convert into a vibroturbulization state instantly.

The above description is given by way of example, and not limitation. Given the above disclosure, one skilled in the art could devise variations that are within the scope and spirit of the invention disclosed herein, including various ways of introducing the metals and alloys into the melting pot. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A molten metal processing machine for mixing two or more materials, the machine comprising:
a crucible defining an interior circular surface and opposed flat inner surfaces which defines an interior space for holding the two or more materials to be mixed, the opposed flat inner surfaces being parallel to each other, the length of the crucible defining a longitudinal axis which is perpendicular to the opposed flat inner surfaces;
a vibration unit attached to the crucible and operative to vibrate the crucible until resonance is reached with the two or more materials so that the two or more materials held in the interior space of the crucible experiences a turbulence phenomenon, the vibration unit defining a single vibration direction which is parallel to the longitudinal axis of the crucible;
a heater attached or adjacent to the crucible for maintaining the two or more materials held in the interior space in the molten state while the vibration unit vibrates the crucible.

2. The machine of claim 1 wherein the vibration direction is vertical.

3. The machine of claim 1 wherein the vibration unit is operative to impart vibration to the crucible at an amplitude between 0.5 to 2.5 mm, at a frequency between 30 to 300 Hz and at an acceleration between 15 to 50 G.

4. The machine of claim 1 wherein the two or more materials fills about 90 to 95% of the volume of the interior space of the crucible.

5. The machine of claim 1 wherein the vibration from the vibration unit is a sinusoidal oscillation.

6. The machine of claim 1 wherein the heater is operative to impart heat to the crucible to melt the two or more materials which are metal.

7. The machine of claim 1 wherein the heater is externally disposed to the crucible to induct heat to the crucible to maintain the two or more materials in the molten state.

8. The machine of claim 1 wherein the crucible is designed and fabricated from a material having a rigidity equal to or greater than steel.

9. A method of mixing two or more materials, the method comprising the steps of:
providing a crucible having opposed flat inner surfaces, which are parallel to each other and axially aligned to each other along a longitudinal axis of the crucible;
filling the crucible with two or more materials;
sealing the crucible;
introducing heat into the crucible to melt and maintain the two or more materials in a molten state;
vibrating the crucible in a direction perpendicular to the opposed flat inner surfaces at a frequency, amplitude and acceleration to impart turbulence to the two or more material in the molten state and hydraulic hammer impact thereof against the opposed flat inner surfaces.

11. The method of claim 9 wherein the filling step includes the step of filling the crucible with a solid material and a gas.

12. The method of claim 9 wherein the filling step includes the step of filling the crucible with two or more immiscible metallic materials.

13. The method of claim 9 wherein the vibration step includes the step of adjusting the amplitude, the frequency and the acceleration of vibration until a resonance is reached so that the two or more materials experience turbulence under simultaneously combined actions of the resonance and the hydraulic hammer impact against the opposed flat inner surfaces of the crucible.

14. The method of claim 10 wherein a sidewalls and top and bottom caps of the crucible are fabricated from a material sufficiently strong and ridged so that the crucible can withstand forces imposed on the crucible when the two or more materials experience turbulence under simultaneously combined actions of the resonance and the hydraulic hammer impact against the opposed flat inner surfaces of the crucible during the vibrating step.

15. A system for processing dispersed systems, comprising: a reactor chamber; a vibration unit coupled to the reactor chamber; at least one input with at least one valve; and at least one output with at least one valve; wherein the vibration unit is configured to vibrate the reactor chamber at a frequency and amplitude sufficient to achieve a vibroturbulization of a multi-component mixture in the reactor chamber.

16. The system for processing dispersed systems of claim 15, wherein the vibration unit is configured to vibrate the reactor chamber at a frequency between 35 Hz and 100 Hz, inclusive.

17. The system for processing dispersed systems of claim 15, wherein the vibration unit is configured to vibrate the reactor chamber at an amplitude between 0.5 mm and 5 mm, inclusive.

18. The system for processing dispersed systems of claim 15, wherein the multi-component mixture comprises a liquid and a gas.

19. The system for processing dispersed systems of claim 18, wherein the multi-component mixture is 90-95% liquid.

20. The system for processing dispersed systems of claim 15, further comprising a vacuum pump.

21. The system for processing dispersed systems of claim 15, further comprising a drainage tank.

22. The system for processing dispersed systems of claim 15, further comprising a ventilation line.

23. The system for processing dispersed systems of claim 15, wherein the multi-component mixture is one of a liquid-liquid, liquid-liquid-gas, liquid-liquid-solid, or liquid-liquid-solid-gas mixture.

24. The system for processing dispersed systems of claim 15, wherein the vibroturbulization is accompanied by: the free surface between the components of the multi-component mixture disappears; the surface of separation between the components of the multi-component mixture increases; the multi-component mixture filling up the total internal volume of the reactor chamber; the development of mass-transfer zones; the increase of internal pressure in the reactor chamber; and the intensification of specific sounds from the reactor chamber.

25. The system for processing dispersed systems of claim 15, wherein a processed product is continuously discharged from the reactor chamber while the multi-component mixture is in a state of vibroturbulization.

26. A method for processing dispersed systems, comprising: inputting a first component into a reactor chamber; inputting a second component into a reactor chamber; and applying a constant vibration to the reactor chamber; wherein the vibration applied to the reactor chamber has a frequency and amplitude to achieve vibroturbulization.

27. The method for processing dispersed systems of claim 26, wherein the vibration applied to the reactor chamber has a frequency between 35-100 Hz, inclusive, and amplitude between 0.5 and 5 mm, inclusive.

28. The method for processing dispersed systems of claim 26, wherein the first component is a liquid and the second component is a gas.

29. The method for processing dispersed systems of claim 26, wherein the vibration is applied to the reactor chamber after inputting the first component and before inputting the second component.

30. The method for processing dispersed systems of claim 26, wherein the vibration is applied to the reactor chamber before inputting either of the first component and the second component.

31. The method for processing dispersed systems of claim 26, further comprising draining a final-processed product.

32. The method for processing dispersed systems of claim 26, further comprising sealing the reactor chamber.

33. The method for processing dispersed systems of claim 26, further comprising inputting a third component into the reactor chamber.

34. The method for processing dispersed systems of claim 33, wherein the third component has a surface tension coefficient, which is different from the surface tension coefficient of either of the first component and the second component.

35. The technological method by pp. 1, 2, 3, 4, 6, 7, 8, 9, 10, and 11 is characterized by the fact that for the achievement of the maximum efficiency of processing of dispersed system under the condition of the developed vibroturbulization phenomenon, all components of the processing system are loaded into mass transfer zones, and processed finish product is discharged from the vibroturbulization zones simultaneously.
